(19) United States
(12) Patent Application Publication
(10) Pub. No.: US 2006/0217868 A1
(43) Pub. Date: Sep. 28, 2006

(54) Method for improving driving stability

(76) Inventors: Andreas Zeller, Frankfurt/Main (DE); Jürgen Karner, Nauheim (DE); Dietmar Bethke, Friedberg (DE)

Correspondence Address: CONTINENTAL TEVES, INC., ONE CONTINENTAL DRIVE, AUBURN HILLLS, MI, 48326-1581, US

(21) Appl. No.: 10/542,968

(22) PCT Filed: Dec. 18, 2003
(86) PCT No.: PCT/EP03/14449

§ 371 Date: Apr. 18, 2006

(30) Foreign Application Priority Data
Jan. 21, 2003 (DE) 103 02 080.2

(51) Int. Cl. B60T 8/72

(52) U.S. Cl. 701/73; 303/149

(57) ABSTRACT

The invention relates to a method and an electronic motor vehicle brake system for increasing the driving stability during electronically controlled braking operations in motor vehicles with rear wheels that are or can be rigidly or substantially rigidly coupled, wherein when a ‘μ-split’ driving situation is detected by the brake control unit used to perform the control tasks, the pressure modulation of the front wheel being at a low coefficient of friction and undergoing electronic control is adopted for both wheels of the rear axle without substantial changes.

### BACKGROUND OF THE INVENTION

The present invention relates to a method of increasing driving stability in motor vehicles during controlled braking operations in a motor vehicle having rear wheels that can be substantially rigidly coupled according and an electronic motor vehicle brake system used to increase driving stability during electronically controlled braking operations.

Especially an improved pressure control for preventing locking of the rear axle in electronic motor vehicle brake systems for vehicles with coupled rear wheels is described, said rear wheels comprising a per se known yaw torque control (YTC) in addition to ABS. A yaw torque control system becomes active when a vehicle is moving on roadways with so-called μ-split conditions, implying that with μ-split conditions different coefficients of friction act on the wheels causing yaw torque that acts on the vehicle.

Apart from the objective of achieving an optimal stopping distance, another objective in a conventional motor vehicle anti-lock system is to safeguard a driving behavior as stable as possible when performing wheel slip control, while renouncing an optimal stopping distance. Therefore, the rear axle in passenger cars is usually controlled according to the ‘select-low’ principle. The ‘select-low’ principle is characterized in that the brake pressure on both rear wheels is determined by the rear wheel having the stronger tendency to lock. This condition safeguards maximum vehicle stability.

An object of the invention is to improve a per se known ABS control method for vehicles with coupled rear wheels (e.g. rigid coupling).

### SUMMARY OF THE INVENTION

According to the invention, this object is achieved by a method for detecting that the vehicle is in a ‘μ-split’ driving situation, performing pressure modulation on a front wheel of the vehicle and performing pressure modulation on the rear wheels. The pressure modulation on the rear wheels is adopted from the pressure modulation on the front wheel without substantial change.

It has shown that the ‘select-low’ principle in vehicles whose rear wheels are e.g. coupled rigidly by way of a locked differential causes an unstable driving behavior above all on roadways with different coefficients of friction.

Among others, the invention is based on the knowledge that the rigid coupling of the rear wheels in connection with the ‘select-low’ principle brings about that the sum of the respectively maximum longitudinal force that can be transmitted by the rear wheels is subdivided in equal shares between both rear wheels.

The term ‘rigid coupling’ implies a permanently prevailing or a detachable rigid coupling of the wheels of the rear axle, and the term ‘rigid’ also includes, at least to a certain extent, elastic or yielding coupling engagements.

The invention discloses a special pressure modulation method for the rear axle, and this special pressure modulation is performed on the rear axle in that the pressure modulation of the front wheel being at a low coefficient of friction is adopted for both wheels of the rear axle without substantial changes.

Due to the rigid coupling of the rear wheels, the almost identical wheel behavior of both rear wheels does not allow concluding the brake pressure at the adhesion limit of one wheel but only the sum of the brake pressures at the adhesion limit of both rear wheels. As the front wheels are not coupled, it is possible to infer the brake pressure at the adhesion limit of one wheel from the behavior of the front wheels. For this reason, the pressure modulation of the front wheel having a low coefficient of friction is adopted for the rear axle.

In a particularly suitable manner, the special pressure modulation method proposed herein can be supplemented in combination with a per se known YTC method. A YTC method during an ABS control operation is used to reduce the yaw torque by means of brake pressure modulation at the front axle especially when ‘μ-split’ roadways are detected.

Consequently, the method of the invention serves to increase driving stability on ‘μ-split’ roadways in vehicles with rigidly coupled rear wheels compared to per se known methods.

In a preferred fashion, further detection mechanisms to avoid slip on the rear axle can be activated in parallel, which have the effect that pressure on both rear wheels is reduced when an imminent unstable wheel behavior is detected on at least one rear wheel.

The special pressure modulation on the rear axle according to the invention is preferably made dependent on a detection signal signaling whether coupling of the rear wheels prevails. It is furthermore suitable to make the function dependent on the issue whether the YTC function on the front axle is active. It is especially expedient when, as a criterion of detecting a ‘μ-split’ roadway, it is monitored whether a YTC function provided in the control unit is currently active.

The pressure increase times and pressure reduction times adopted for the rear axle from the front wheel having a low coefficient of friction, admittedly, are adopted without substantial changes, yet can be weighted slightly differently in the sense of the invention. Discrepancies are generally limited to the effect of compensating possibly existing hydraulic differences (e.g. volume absorption, line cross-section, switching orifice) in the brake circuit of the front and rear axles. Preferably, the front wheel having a low coefficient of friction is detected by making a check whether an active YTC function on this wheel does not intervene in the current situation.

Further preferred embodiments can be taken from the following description of the Figures.

The invention is explained in detail in the following by way of examples.

### BRIEF DESCRIPTION OF THE DRAWINGS

In the drawings:

FIG. 1 shows an illustration of driving parameters during an ABS controlled braking operation with a ‘select-low’ control on the rear axle ‘μ-split’ roadway;

FIG. 2 shows a corresponding illustration of these driving parameters after the method of the invention has been implemented.

### DETAILED DESCRIPTION OF THE DRAWINGS

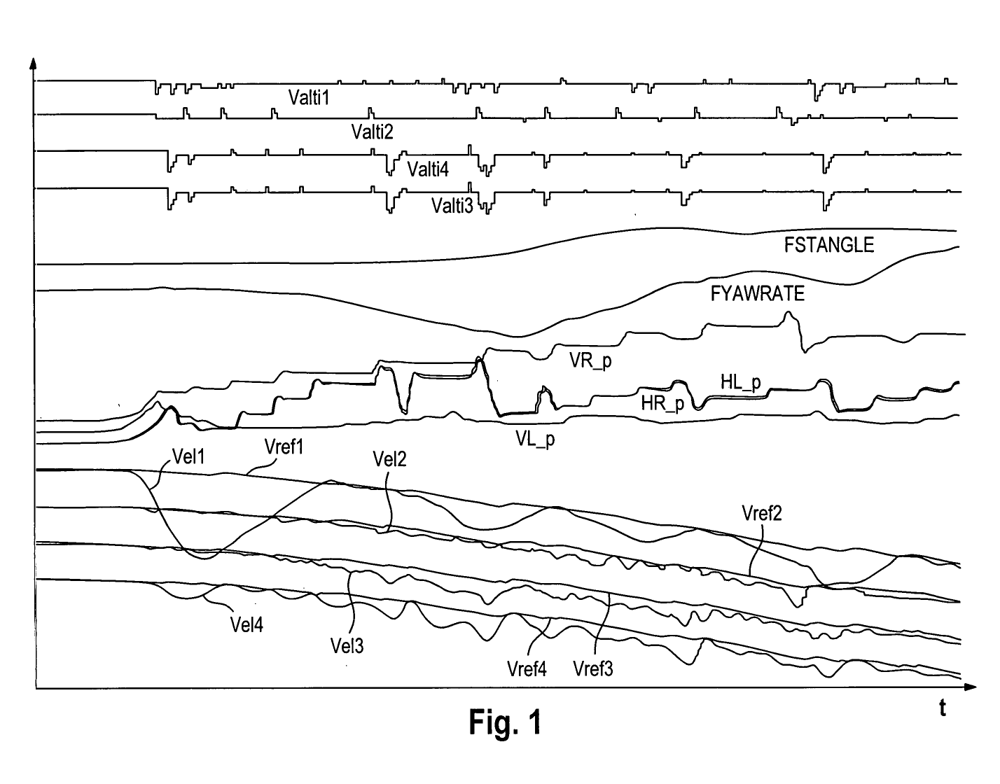

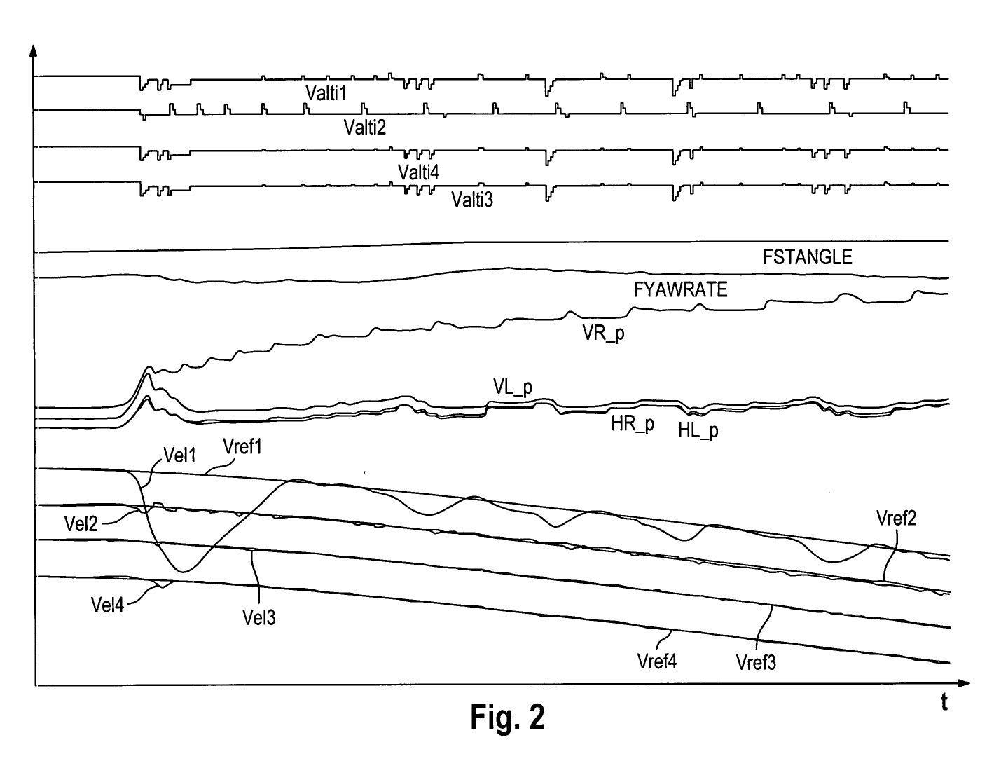

Referring to FIGS. 1 and 2, the vehicle reference speeds v_{ref1} to v_{ref4} (derived from v_{ref}) have been plotted against time t jointly with the wheel speeds (vₑ₁₁ to vₑ₁₄) of the individual vehicle wheels for the wheels 1 to 4. The wheels ‘left front’, ‘right front’, ‘left rear’, and ‘right rear’ have generally been designated numerals 1 to 4. Further, the yaw rate FYAWRATE and the current steering angle FSTANGLE of the vehicle are plotted as a function of time t. The curves Vₐₗₜᵢ₁ to Vₐₗₜᵢ₄ indicate the time variation of the condition of the inlet and outlet valve for the wheels 1 to 4 adjusted by the control unit. The curves VR_p, VL_p, HR_p and HL_p represent the currently prevailing pressure in the corresponding wheel cylinders.

It becomes apparent from FIG. 1 that during an ABS braking operation on μ-split the wheel speed veil of wheel 1 (left front) drops below the vehicle reference speed. In the further course of time, during an activated ABS control, the wheel speeds of the two rear wheels vₑ₁₃ and ve₁₄ drop to a value below the reference speed V_{ref}. In consequence thereof, the rear wheels can transmit only a small amount of lateral force onto the roadway. The vehicle becomes unstable. In addition, the YTC function of the ABS control unit builds up a yaw torque acting on the vehicle on the front axle, what causes swerving of the vehicle, as can be seen from the course of the curves of the yaw rate FYAWRATE and from the steering angle FSTANGLE influenced by the driver.

FIG. 2 shows an ABS-controlled braking operation that is supplemented by the method of the present invention. The curve Vₐₗₜᵢ₁ shows the actuation signals of the front wheel ‘left front’, which has a lower coefficient of friction than the front wheel ,right front’. The pressure reduction on the front wheel ,right front’ is therefore lower, as can be seen from curve Vₐₗₜᵢ₂. Therefore, also the pressure in the wheel brake of the right front wheel VR_p is higher than in the wheel brake of the left front wheel VL_p. In the example, the valve actuation signals Vₐₗₜᵢ₁ for the left front wheel ‘left front’ are also sent to both wheels of the rear axle Vₐₗₜᵢ₃ and Vₐₗₜᵢ₄. As is shown in the curves of the yaw rate, the steering angle and the wheel speeds, the vehicle remains stable in this case. Compared to the per se known ABS controlled braking operation according to the ‘select-low’ principle in FIG. 1, the amplitude of the vehicle yaw rate (FYAWRATE) is lower so that the driver is less demanded to correct the vehicle yaw rate by way of a change in the steering angle (FSTANGLE).

Method for Improving Driving Stability

Disclosed are a method and electronic brake system utilized to increase driving stability of a motor vehicle during electronically controlled braking operations. The motor vehicle has rear wheels that may be rigidly coupled. The method performs pressure modulation on a front wheel and both rear wheels. The pressure modulation performed on the rear wheels is adopted from the pressure modulation on the front wheel.

1-5. (canceled)

6. A method for increasing driving stability during electronically controlled braking operations in a motor vehicle having rear wheels that can be substantially rigidly coupled, the method comprising:
detecting that the vehicle is in a ‘μ-split’ driving situation, wherein a ‘μ-split’ driving situation is defined as a situation where different coefficients of friction act on different wheels causing a yaw torque that acts on the vehicle,
performing pressure modulation on at least one front wheel of the vehicle; and
performing pressure modulation on both wheels of a rear axle of the vehicle;
wherein the pressure modulation performed on both rear wheels is adopted from the pressure modulation on the at least one front wheel without substantial changes.

7. The method of claim 6, wherein the pressure modulation performed on both rear wheels is adapted depending on one or more specific physical properties of the vehicle brake system, wherein the one or more specific physical property includes hydraulic differences of the front-wheel brakes and rear-wheel brakes.

8. The method of claim 7, wherein the adaptation of the pressure modulation performed on both rear wheels is effected by differently weighting pressure increase times and pressure reduction times on the rear axle.

9. The method of claim 7, wherein in parallel to the adoption of the pressure modulation, further ABS control functions which act on the rear axle are parallel active so that pressure is reduced on both rear wheels when an unstable wheel behavior is imminent on at least one rear wheel.

10. Electronic motor vehicle brake system for increasing driving stability during electronically controlled braking operations in a motor vehicle having rear wheels that can be substantially rigidly coupled, the system comprising:
a device for detecting that the vehicle is in a ‘μ-split’ driving situation, wherein a ‘μ-split’ driving situation is defined as a situation where different coefficients of friction act on different wheels causing a yaw torque that acts on the vehicle; and
an electronic brake control unit for controlling pressure modulation on at least one front wheel of the vehicle and for controlling pressure modulation on both wheels of a rear axle of the vehicle; wherein the pressure modulation performed on both rear wheels is adopted from the pressure modulation on the at least one front wheel without substantial changes.
